(19) United States
(12) Patent Application Publication
(10) Pub. No.: US 2021/0362749 A1
(43) Pub. Date: Nov. 25, 2021

(54) HARDWARE ACCELERATED NETWORK INTERFACE FOR AN AUTONOMOUS VEHICLE SWITCHED-NETWORK

(71) Applicant: GM Cruise Holdings LLC, San Francisco, CA (US)

(72) Inventors: Christopher Berry, Los Altos, CA (US); Matthew Fornero, Oakland, CA (US); Cameron Matzke, Palo Alto, CA (US)

(21) Appl. No.: 16/879,305

(22) Filed: May 20, 2020

(51) Int. Cl. B60W 60/00; G06K 9/00; G01C 21/34

(52) U.S. Cl. CPC B60W 60/0025; G06K 9/00791; G01C 21/3438; H04W 4/44; B60W 2420/52; B60W 2420/403; B60W 2556/50; B60W 2754/10

(57) ABSTRACT

The subject disclosure relates to features that reduce computational overhead needed to transport sensor data through an autonomous vehicle (AV) network. In some aspects, a process of the disclosed technology includes steps for receiving a plurality of sensor packets at an accelerated AV network pipeline, extracting frame information associated with the plurality of sensor packets, and extracting payload data from the plurality of sensor packets based on the associated frame information to produce a plurality of de-capsulated sensor packets. Systems and machine-readable media are also provided.

### BACKGROUND

### 1. Technical Field

The subject technology provides solutions for improving data transport in a switch-network and in particular, for improving transport of sensor data streams to compute nodes of an autonomous vehicle (AV).

### 2. Introduction

Autonomous vehicles (AVs) are vehicles having computers and control systems that perform driving and navigation tasks that are conventionally performed by a human driver. As AV technologies continue to advance, ride-sharing services will increasingly utilize AVs to improve service efficiency and safety. However, for effective use in ride-sharing deployments, AVs will be required to perform many of the functions that are conventionally performed by human drivers, such as performing navigation and routing tasks necessary to provide a safe and efficient ride service. Such tasks may require the collection and processing of large quantities of data using various sensor types, including but not limited to cameras and/or Light Detection and Ranging (LiDAR) sensors disposed on the AV.

### BRIEF DESCRIPTION OF THE DRAWINGS

Certain features of the subject technology are set forth in the appended claims. However, the accompanying drawings, which are included to provide further understanding, illustrate disclosed aspects and together with the description serve to explain the principles of the subject technology. In the drawings:

FIG. 1 illustrates an example system environment that can be used to facilitate AV navigation and routing operations, according to some aspects of the disclosed technology.

FIG. 2 illustrates an example of an autonomous vehicle (AV) network interface that includes an accelerated data pipeline, according to some aspects of the disclosed technology.

FIG. 3 illustrates an accelerated data pipeline for facilitating the ingestion of sensor data streams by one or more compute nodes in an autonomous vehicle (AV), according to some aspects of the disclosed technology.

FIG. 4 illustrates steps of an example process for implementing an accelerated data pipeline, according to some aspects of the disclosed technology.

FIG. 5 illustrates an example processor-based system with which some aspects of the subject technology can be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

As described herein, one aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

Autonomous vehicle (AV) sensors can generate extremely large amounts of data, which must be ingested by the various computational nodes in the system. For example, AV environmental sensors, including but not limited to: cameras, Light Detection and Ranging (LiDAR), sensors and/or radar sensors, etc. are used to sense the surrounding environment to facilitate AV navigation and maneuver functions. Data collected and provided by these sensors (e.g., sensor streams or data streams) can be transported over an AV-internal switched-based network system, wherein a logical unit of sensor data (frame) is broken into multiple network packets, each with header and payload information.

Before data frames can be provided to various compute nodes, the sensor data payload must be extracted (separated) from other metadata, such as the packet header information, etc. The overhead of extracting sensor frames from the network packets can consume substantial amounts of computing resources, which would be better dedicated to performing other computational functions. However, due to the various sensor modalities potentially deployed in the AV sensor array, sensor packet de-capsulation and encapsulation functions cannot be managed by globally imposing a specific network packet format or RDMA protocol.

Additionally, in some AV sensor implementations, incoming sensor frames may need to be to be transformed before ingestion by the compute elements. Doing this with a CPU can be computationally expensive, and may add latency to the processing of sensor data.

Aspects of the disclose technology address the foregoing limitations of sensor data transport by providing solutions for facilitating sensor packet encapsulation and de-capsulation functions. The disclosed technology also provides an accelerated data pipeline that is configured to perform data transforms on sensor payloads before frame reconstruction is performed, e.g., in a compute element memory. As discussed in further detail below, by providing hardware-based acceleration solutions for sensor data streams, the disclosed accelerated network interface can be implemented with arbitrary network packets and sensor modalities, for example, without the need to impose specific data protocols.

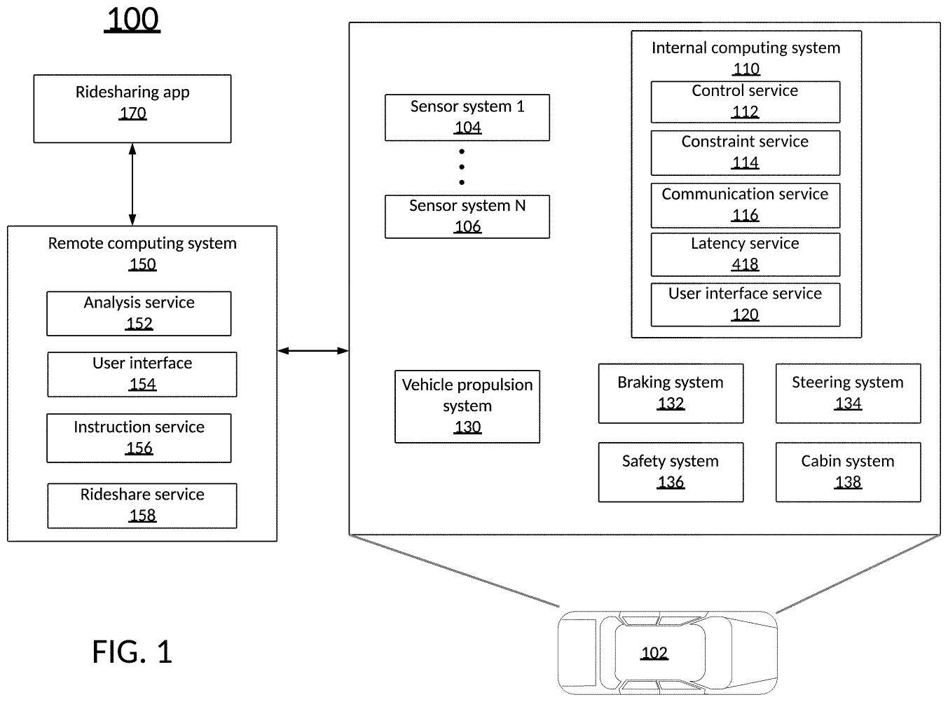

FIG. 1 illustrates an example system environment 100 that can be used to facilitate AV dispatch and operations, according to some aspects of the disclosed technology. Autonomous vehicle 102 can navigate about roadways without a human driver based upon sensor signals output by sensor systems 104-106 of autonomous vehicle 102. Autonomous vehicle 102 includes a plurality of sensor systems 104-106 (a first sensor system 104 through an Nth sensor system 106). Sensor systems 104-106 are of different types and are arranged about the autonomous vehicle 102. For example, first sensor system 104 may be a camera sensor system and the Nth sensor system 106 may be a Light Detection and Ranging (LIDAR) sensor system. Other exemplary sensor systems include radio detection and ranging (RADAR) sensor systems, Electromagnetic Detection and Ranging (EmDAR) sensor systems, Sound Navigation and Ranging (SONAR) sensor systems, Sound Detection and Ranging (SODAR) sensor systems, Global Navigation Satellite System (GNSS) receiver systems such as Global Positioning System (GPS) receiver systems, accelerometers, gyroscopes, inertial measurement units (IMU), infrared sensor systems, laser rangefinder systems, ultrasonic sensor systems, infrasonic sensor systems, microphones, or a combination thereof. While four sensors 180 are illustrated coupled to the autonomous vehicle 102, it is understood that more or fewer sensors may be coupled to the autonomous vehicle 102.

Autonomous vehicle 102 further includes several mechanical systems that are used to effectuate appropriate motion of the autonomous vehicle 102. For instance, the mechanical systems can include but are not limited to, vehicle propulsion system 130, braking system 132, and steering system 134. Vehicle propulsion system 130 may include an electric motor, an internal combustion engine, or both. The braking system 132 can include an engine brake, brake pads, actuators, and/or any other suitable componentry that is configured to assist in decelerating autonomous vehicle 102. In some cases, braking system 132 may charge a battery of the vehicle through regenerative braking. Steering system 134 includes suitable componentry that is configured to control the direction of movement of the autonomous vehicle 102 during navigation. Autonomous vehicle 102 further includes a safety system 136 that can include various lights and signal indicators, parking brake, airbags, etc. Autonomous vehicle 102 further includes a cabin system 138 that can include cabin temperature control systems, in-cabin entertainment systems, etc.

Autonomous vehicle 102 additionally comprises an internal computing system 110 that is in communication with sensor systems 180 and systems 130, 132, 134, 136, and 138. Internal computing system 110 includes at least one processor and at least one memory having computer-executable instructions that are executed by the processor. The computer-executable instructions can make up one or more services responsible for controlling autonomous vehicle 102, communicating with remote computing system 150, receiving inputs from passengers or human co-pilots, logging metrics regarding data collected by sensor systems 180 and human co-pilots, etc.

Internal computing system 110 can include a control service 112 that is configured to control operation of vehicle propulsion system 130, braking system 132, steering system 134, safety system 136, and cabin system 138. Control service 112 receives sensor signals from sensor systems 180 as well communicates with other services of internal computing system 110 to effectuate operation of autonomous vehicle 102. In some embodiments, control service 112 may carry out operations in concert one or more other systems of autonomous vehicle 102. Internal computing system 110 can also include constraint service 114 to facilitate safe propulsion of autonomous vehicle 102. Constraint service 116 includes instructions for activating a constraint based on a rule-based restriction upon operation of autonomous vehicle 102. For example, the constraint may be a restriction upon navigation that is activated in accordance with protocols configured to avoid occupying the same space as other objects, abide by traffic laws, circumvent avoidance areas, etc. In some embodiments, the constraint service can be part of control service 112.

The internal computing system 110 can also include communication service 116. The communication service 116 can include both software and hardware elements for transmitting and receiving signals from/to the remote computing system 150. Communication service 116 is configured to transmit information wirelessly over a network, for example, through an antenna array that provides personal cellular (long-term evolution (LTE), 3G, 4G, 5G, etc.) communication.

Internal computing system 110 can also include latency service 118. Latency service 118 can utilize timestamps on communications to and from remote computing system 150 to determine if a communication has been received from the remote computing system 150 in time to be useful. For example, when a service of the internal computing system 110 requests feedback from remote computing system 150 on a time-sensitive process, the latency service 118 can determine if a response was timely received from remote computing system 150 as information can quickly become too stale to be actionable. When the latency service 118 determines that a response has not been received within a threshold, latency service 118 can enable other systems of autonomous vehicle 102 or a passenger to make necessary decisions or to provide the needed feedback.

Internal computing system 110 can also include a user interface service 120 that can communicate with cabin system 138 in order to provide information or receive information to a human co-pilot or human passenger. In some embodiments, a human co-pilot or human passenger may be required to evaluate and override a constraint from constraint service 114, or the human co-pilot or human passenger may wish to provide an instruction to the autonomous vehicle 102 regarding destinations, requested routes, or other requested operations.

As described above, the remote computing system 150 is configured to send/receive a signal from the autonomous vehicle 140 regarding reporting data for training and evaluating machine learning algorithms, requesting assistance from remote computing system 150 or a human operator via the remote computing system 150, software service updates, rideshare pickup and drop off instructions, etc.

Remote computing system 150 includes an analysis service 152 that is configured to receive data from autonomous vehicle 102 and analyze the data to train or evaluate machine learning algorithms for operating the autonomous vehicle 102. The analysis service 152 can also perform analysis pertaining to data associated with one or more errors or constraints reported by autonomous vehicle 102. Remote computing system 150 can also include a user interface service 154 configured to present metrics, video, pictures, sounds reported from the autonomous vehicle 102 to an operator of remote computing system 150. User interface service 154 can further receive input instructions from an operator that can be sent to the autonomous vehicle 102.

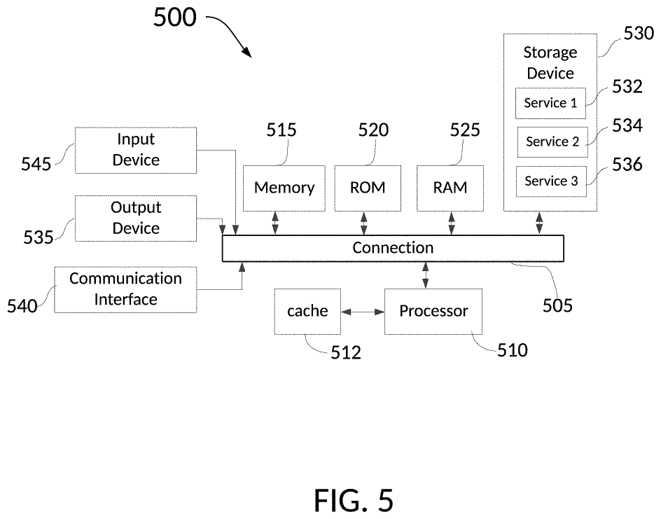

Remote computing system 150 can also include an instruction service 156 for sending instructions regarding the operation of the autonomous vehicle 102. For example, in response to an output of the analysis service 152 or user interface service 154, instructions service 156 can prepare instructions to one or more services of the autonomous vehicle 102 or a co-pilot or passenger of the autonomous vehicle 102. Remote computing system 150 can also include rideshare service 158 configured to interact with ridesharing applications 170 operating on (potential) passenger computing devices. The rideshare service 158 can receive requests to be picked up or dropped off from passenger ridesharing app 170 and can dispatch autonomous vehicle 102 for the trip. The rideshare service 158 can also act as an intermediary between the ridesharing app 170 and the autonomous vehicle wherein a passenger might provide instructions to the autonomous vehicle to 102 go around an obstacle, change routes, honk the horn, etc. Remote computing system 150 can, in some cases, include at least one computing system 150 as illustrated in or discussed with respect to FIG. 5, or may include at least a subset of the components illustrated in FIG. 5 or discussed with respect to computing system 150.

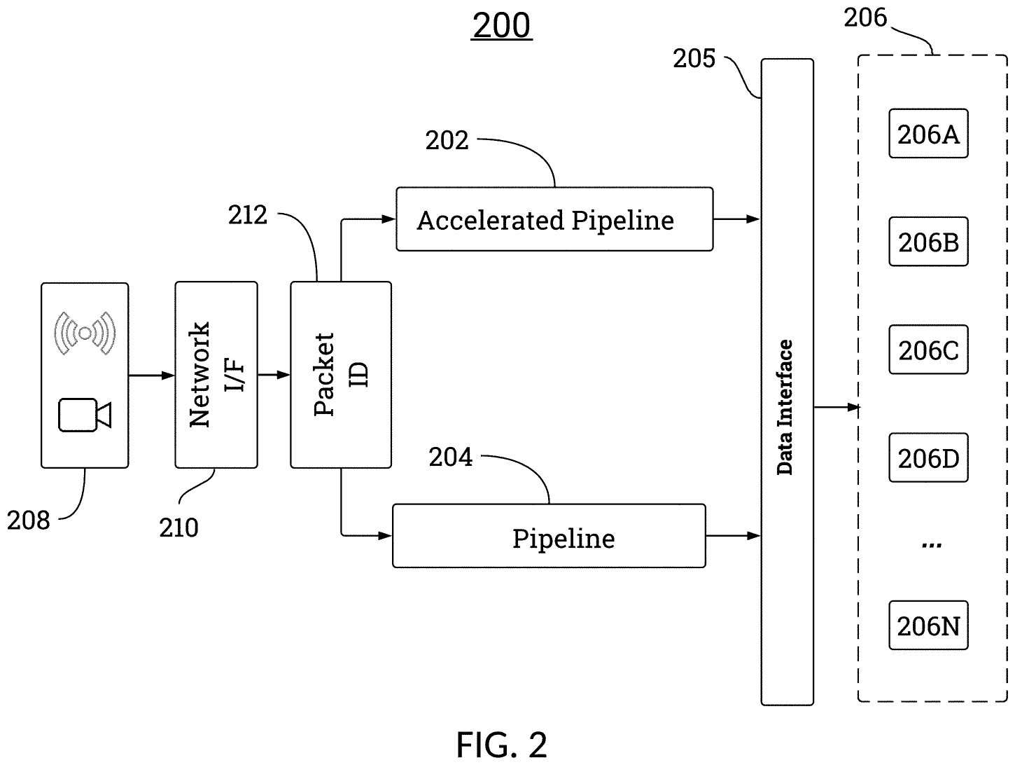

FIG. 2 illustrates an example of an autonomous vehicle (AV) network interface 200 that includes an accelerated data pipeline 202 and a standard network pipeline 204, according to some aspects of the disclosed technology. Accelerated pipeline 202 can be configured to transport sensor data streams that require acceleration, whereas pipeline 204 can be configured for transporting other data packets. For example, in some implementations, streams carrying data relating to CPU communications (e.g., CPU-to-CPU communication), system level controls, and/or sensor controls can be transported via pipeline 204. Additionally, pipeline 204 can be used for transport of low-bandwidth sensor data streams, for example, that do not require multi-packet frame reconstruction. Depending on the desired implementation, other types of data can be transported via pipeline 204, without departing from the scope of the technology.

In practice, sensor data streams can originate with one or more AV sensors 208, which can include, but are not limited to one or more: cameras, LiDAR sensors, radar sensors, or the like. Data streams generated by AV sensors 208 are transmitted to a packet identification module 212, via a network interface 210. In operation, packet ID module 212 can perform functionality necessary to determine the type/s of packets transported over interface 200, and to make routing decisions necessary to guide the packets to compute nodes 206, via accelerated pipeline 202, or pipeline 204, e.g., via data interface 205.

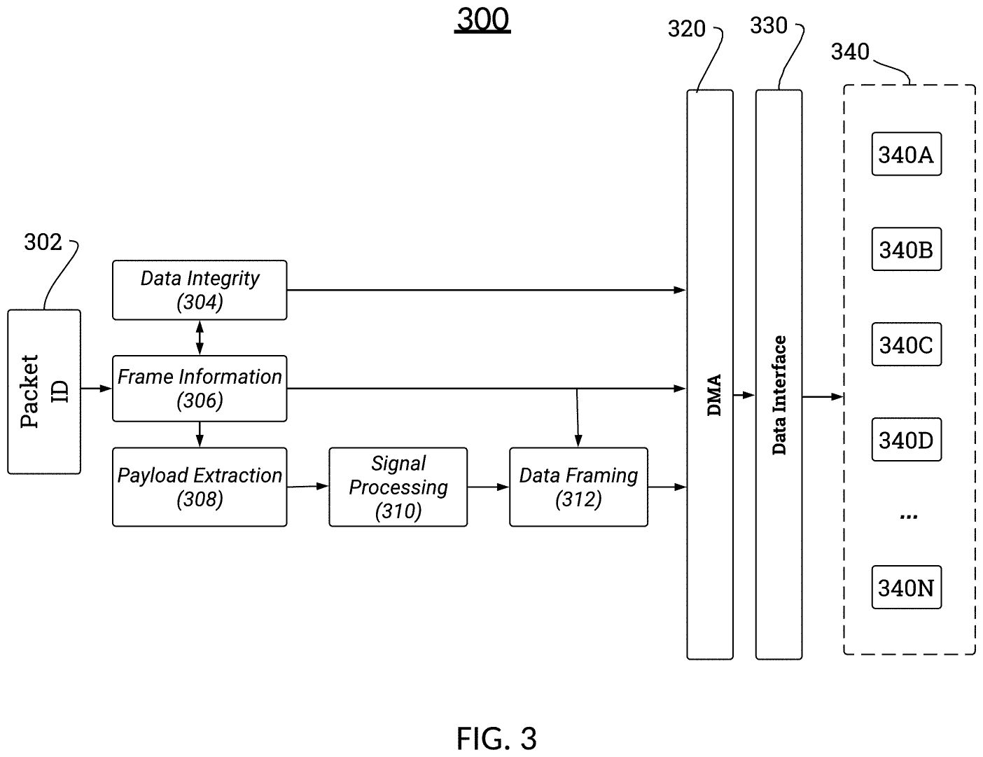

As discussed in further detail below with respect to FIG. 3, accelerated pipeline 202 can perform encapsulation and/or de-capsulation functions necessary to extract payload sensor data from various sensor streams. Accelerated pipeline 202 can also perform signal processing and data transformation functions, depending on the operations required by the specific sensor modality. By way of example, data transforms that may be routinely performed by accelerated pipeline 202 can include but are not limited to: compression and/or decompression, color space transformations (e.g., for camera data), and/or coordinate transforms (e.g., for LiDAR or radar data). Lastly, compute nodes 206 (e.g., 206A, 206B, 206C, 206D . . . 206N) receive the data packets and perform frame reconstruction operations needed to fully ingest/consume the received sensor data.

It is understood that compute nodes 206 can represent one or more processing elements, including but not limited to one or more Central Processing Units (CPUs), Graphics Processing Units (GPUs), Machine Learning Accelerators (MLAs) and/or other processor architectures, without departing from the scope of the disclosed technology. Additionally, a greater (or fewer) number of total compute nodes may be implemented, without departing from the scope of the disclosed technology. Further details regarding the implementation of processor-based systems are provided in relation to FIG. 5, discussed below.

FIG. 3 illustrates an accelerated data pipeline 300 for facilitating ingestion of sensor data streams by one or more compute nodes 340, according to some aspects of the disclosed technology. Accelerated data pipeline 300 can represent an example of hardware components used to implement sensor data de-capsulation/encapsulation, and transformation functions discussed above with respect to accelerated pipeline 202.

In practice, sensor data packets for one or more sensor data streams are received at frame information module 306, which is configured to extract frame information associated with the received sensor packets. Frame information extracted by frame information module 306 can be used to determine what type of sensor data is represented by the payloads of the received packets. Extracted frame information can be used to inform downstream operations and in particular, functions performed by payload extraction module 308, signal processing module 310, and/or data framing module 312. In some aspects, frame information can include data indicating one or more switch network identifiers that can then be mapped on to particular functionalities that are performed by one or more downstream hardware units.

Frame information can be transmitted from frame information module 306 to payload extraction module 308, as well as one or more of compute nodes 340. By ascertaining the sensor modality from the extracted frame information, payload extraction module can discern what portions of packet data are payload data, and what portions are metadata (e.g., packet headers etc.). Accordingly, payload extraction module 308 can de-capsulate packets before passing them to signal processing module 310.

Signal processing module 310 can perform signal processing operations (data transformations) that may be required before sensor data consumption by compute nodes 340. Transformation functions can be specific to a particular sensor type, i.e., informed by the nature of the extracted frame information. As discussed above, data transforms can include but are not limited to, compression and/or decompression, color space transformations (e.g., for camera data), and/or coordinate transforms (e.g., for LiDAR or radar data). It is understood that other types of transformations may be implemented by signal processing module 310, without departing from the scope of the disclosed technology.

Transformed payload sensor data is then passed to data framing module 312, which is configured to facilitate frame reconstruction so that the sensor data can be consumed by one or more of compute nodes 340. Similar to payload extraction module 308, and signal processing module 310, operations of data framing module 312 are determined based on the sensor type, e.g., ascertained from the extracted frame information. Frame reconstruction can also be based on the purpose of sensor data consumption. For example, data streams for similar sensor modalities may be differently reconstructed, based on the downstream computing necessity. Reconstructed frames sensor data frames are then provided to compute nodes 340 (e.g., 340A, 340B, 340C, 340D . . . 340N), via direct memory access (DMA) module 320, and data interface 330. By way of example, DMA module 320 can be configured to place the reconstructed frames into a memory of a specific destination compute node.

As discussed above, compute nodes 340 can represent one or more processing elements, including but not limited to one or more Central Processing Units (CPUs), Graphics Processing Units (GPUs), and/or other processor architectures, without departing from the scope of the disclosed technology. Further details regarding the implementation of processor-based systems are provided in relation to FIG. 5, discussed below.

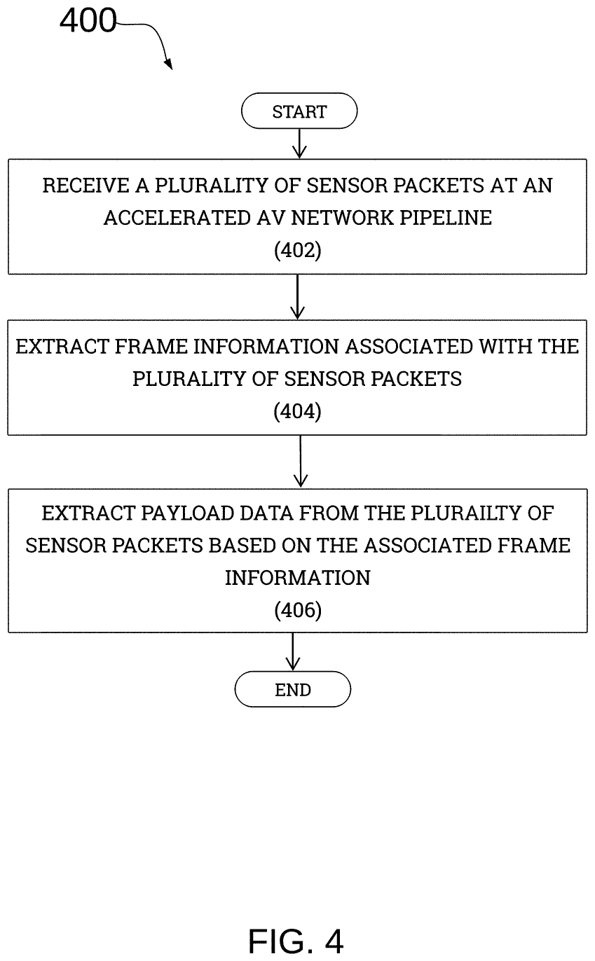

FIG. 4 illustrates steps of an example process 400 for implementing an accelerated data pipeline, according to some aspects of the disclosed technology. Process 400 begins with step 402 in which one or more sensor data packets are received, e.g., at an accelerated network interface as discussed above with respect to FIGS. 2 and 3. Sensor data packets can represent data pulled from various AV sensors and sensor modalities. As such, the sensor data packets can correspond with different data streams for different sensors.

In step 404, frame information is extracted from the sensor packets, e.g., by a frame extraction module such as frame extraction module 306, discussed above. Frame information can contain switch network identifiers that identify the sensor (type) originating the data, and which can be used to inform the functionality downstream modules. For example, frame information can be used to determine how packet de-capsulation and/or encapsulation can be performed, select one or more data transforms to be applied on corresponding sensor payload data, and/or can be used to facilitate reconstruction of one or more sensor frames, e.g., by a data framing module and/or one or more compute nodes.

In step 406, payload (sensor) data is extracted from the sensor packets based on the associated frame information. As discussed above, various computational transformation can then be performed on the extracted payload data (i.e., de-capsulated sensor packets), before the sensor data is re-framed and provided to one or more compute nodes for consumption, e.g., via a DMA interface.

FIG. 5 illustrates an example processor-based system with which some aspects of the subject technology can be implemented. For example, processor-based system 500 that can be any computing device making up internal computing system 410, remote computing system 450, a passenger device executing the rideshare app 470, internal computing device 430, or any component thereof in which the components of the system are in communication with each other using connection 505. Connection 505 can be a physical connection via a bus, or a direct connection into processor 510, such as in a chipset architecture. Connection 505 can also be a virtual connection, networked connection, or logical connection.

In some embodiments, computing system 500 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 500 includes at least one processing unit (CPU or processor) 510 and connection 505 that couples various system components including system memory 515, such as read-only memory (ROM) 520 and random-access memory (RAM) 525 to processor 510. Computing system 500 can include a cache of high-speed memory 512 connected directly with, in close proximity to, and/or integrated as part of processor 510.

Processor 510 can include any general purpose processor and a hardware service or software service, such as services 532, 534, and 536 stored in storage device 530, configured to control processor 510 as well as a special-purpose processor where software instructions are incorporated into the actual processor design. Processor 510 may essentially be a completely self-contained computing system, containing multiple cores or processors, a bus, memory controller, cache, etc. A multi-core processor may be symmetric or asymmetric.

To enable user interaction, computing system 500 includes an input device 545, which can represent any number of input mechanisms, such as a microphone for speech, a touch-sensitive screen for gesture or graphical input, keyboard, mouse, motion input, speech, etc. Computing system 500 can also include output device 535, which can be one or more of a number of output mechanisms known to those of skill in the art. In some instances, multimodal systems can enable a user to provide multiple types of input/output to communicate with computing system 500. Computing system 500 can include communications interface 540, which can generally govern and manage the user input and system output. The communication interface may perform or facilitate receipt and/or transmission wired or wireless communications via wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

Communications interface 540 may also include one or more Global Navigation Satellite System (GNSS) receivers or transceivers that are used to determine a location of the computing system 500 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 530 can be a non-volatile and/or non-transitory computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

Storage device 530 can include software services, servers, services, etc., that when the code that defines such software is executed by the processor 510, it causes the system to perform a function. In some embodiments, a hardware service that performs a particular function can include the software component stored in a computer-readable medium in connection with the necessary hardware components, such as processor 510, connection 505, output device 535, etc., to carry out the function.

As understood by those of skill in the art, machine-learning based classification techniques can vary depending on the desired implementation. For example, machine-learning classification schemes can utilize one or more of the following, alone or in combination: hidden Markov models; recurrent neural networks; convolutional neural networks (CNNs); deep learning; Bayesian symbolic methods; general adversarial networks (GANs); support vector machines; image registration methods; applicable rule-based system. Where regression algorithms are used, they may include including but are not limited to: a Stochastic Gradient Descent Regressor, and/or a Passive Aggressive Regressor, etc.

Machine learning classification models can also be based on clustering algorithms (e.g., a Mini-batch K-means clustering algorithm), a recommendation algorithm (e.g., a Miniwise Hashing algorithm, or Euclidean Locality-Sensitive Hashing (LSH) algorithm), and/or an anomaly detection algorithm, such as a Local outlier factor. Additionally, machine-learning models can employ a dimensionality reduction approach, such as, one or more of: a Mini-batch Dictionary Learning algorithm, an Incremental Principal Component Analysis (PCA) algorithm, a Latent Dirichlet Allocation algorithm, and/or a Mini-batch K-means algorithm, etc.

FIG. 5 illustrates an example processor-based system with which some aspects of the subject technology can be implemented. Specifically, FIG. 5 illustrates system architecture 500 wherein the components of the system are in electrical communication with each other using a bus 505. System architecture 500 can include a processing unit (CPU or processor) 510, as well as a cache 512, that are variously coupled to system bus 505. Bus 505 couples various system components including system memory 515, (e.g., read only memory (ROM) 520 and random access memory (RAM) 525, to processor 510.

System architecture 500 can include a cache of high-speed memory connected directly with, in close proximity to, or integrated as part of the processor 510. System architecture 500 can copy data from the memory 515 and/or the storage device 530 to the cache 512 for quick access by the processor 510. In this way, the cache can provide a performance boost that avoids processor 510 delays while waiting for data. These and other modules can control or be configured to control the processor 510 to perform various actions. Other system memory 515 may be available for use as well. Memory 515 can include multiple different types of memory with different performance characteristics. Processor 510 can include any general purpose processor and a hardware module or software module, such as module 1 (532), module 2 (534), and module 3 (536) stored in storage device 530, configured to control processor 510 as well as a special-purpose processor where software instructions are incorporated into the actual processor design. Processor 510 may essentially be a completely self-contained computing system, containing multiple cores or processors, a bus, memory controller, cache, etc. A multi-core processor may be symmetric or asymmetric.

To enable user interaction with the computing system architecture 500, an input device 545 can represent any number of input mechanisms, such as a microphone for speech, a touch-sensitive screen for gesture or graphical input, keyboard, mouse, motion input, speech and so forth. An output device 535 can also be one or more of a number of output mechanisms. In some instances, multimodal systems can enable a user to provide multiple types of input to communicate with the computing system architecture 500. Communications interface 540 can generally govern and manage the user input and system output. There is no restriction on operating on any particular hardware arrangement and therefore the basic features here may easily be substituted for improved hardware or firmware arrangements as they are developed.

Storage device 530 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 525, read only memory (ROM) 520, and hybrids thereof.

Storage device 530 can include software modules 532, 534, 536 for controlling processor 510. Other hardware or software modules are contemplated. Storage device 530 can be connected to the system bus 505. In one aspect, a hardware module that performs a particular function can include the software component stored in a computer-readable medium in connection with the necessary hardware components, such as the processor 510, bus 505, output device 535, and so forth, to carry out various functions of the disclosed technology.

By way of example, instruction stored on computer-readable media can be configured to cause one or more processors to perform operations including: receiving, at an AV computing system, a first dispatch request, wherein the first dispatch request is associated with a first user identifier (ID), receiving, at the AV computing system, a first recognition model, wherein the first recognition model corresponds with the first user ID, receiving, at the AV computing system, an image stream comprising one or more images of pedestrian faces, and providing the one or more images to the first recognition model. In some aspects, the instructions can further cause processors 510 to perform operations for: determining, using the first recognition model, if a first user represented in the one or more images corresponds with the first user ID, unlocking a door of the AV in response to a match between at least one of the one or more images and the first user ID, and/or updating the first recognition model in response to a match between at least one of the one or more images and the first user ID.

In some aspects, memory stored operations/instructions can be configured to further cause processors 510 to perform operations for: receiving a second recognition model corresponding with a second user ID, providing the one or more images to the second recognition model, and determining, using the second recognition model, if a second user represented by the one or more images corresponds with the second user ID. In some approaches, the operations may further cause the processors to perform operations for unlocking a door of the AV in response to a match between at least one of the one or more images and the second user ID.

Depending on the desired implementation, the first recognition model can be a machine-learning model that has been trained using a plurality of facial images of the first user, and wherein the second recognition model is a machine-learning model that has been trained using a plurality of facial images of the second user.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules can be located in both local and remote memory storage devices.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure. Claim language reciting “at least one of” a set indicates that one member of the set or multiple members of the set satisfy the claim.

What is claimed is:

1. A system for routing sensor data in an autonomous vehicle (AV), network the system comprising:
one or more processors;
a network interface coupled to the one or more processors;
one or more autonomous vehicle (AV) sensors coupled to the network interface; and
a computer-readable medium coupled to the one or more processors, wherein the computer-readable medium comprises instructions, which when executed by the processors, cause the processors to perform operations comprising:
receiving a plurality of sensor packets at an accelerated AV network pipeline;
extracting frame information associated with the plurality of sensor packets; and
extracting payload data from the plurality of sensor packets based on the associated frame information to produce a plurality of de-capsulated sensor packets.

2. The system of claim 1, wherein the frame information comprises one or more switch network identifiers corresponding to a Light Detection and Ranging (LiDAR) data stream.

3. The system of claim 1, wherein the frame information comprises one or more switch network identifiers corresponding to a camera data stream.

4. The system of claim 1, wherein the frame information comprises one or more switch network identifiers corresponding to a radar data stream.

5. The system of claim 1, wherein the instructions are further configured to cause the processors to perform operations comprising:
performing a transformation on at least one of the plurality of de-capsulated sensor packets, wherein the transformation comprises one or more of: data compression, or data decompression.

6. The system of claim 1, wherein the instructions are further configured to cause the processors to perform operations comprising:
performing a transformation on at least one of the plurality of de-capsulated sensor packets, wherein the transformation comprises a color space transformation.

7. The system of claim 1, wherein the instructions are further configured to cause the processors to perform operations comprising:
performing a transformation on at least one of the plurality of de-capsulated sensor packets, wherein the transformation comprises a coordinate transform.

8. A computer-implemented method comprising:
receiving, from one or more autonomous vehicle (AV) sensors, a plurality of sensor packets at an accelerated AV network pipeline;
extracting frame information associated with the plurality of sensor packets; and
extracting payload data from the plurality of sensor packets based on the associated frame information to produce a plurality of de-capsulated sensor packets.

9. The computer-implemented method of claim 8, wherein the frame information comprises one or more switch network identifiers corresponding to a Light Detection and Ranging (LiDAR) data stream.

10. The computer-implemented method of claim 8, wherein the frame information comprises one or more switch network identifiers corresponding to a camera data stream.

11. The computer-implemented method of claim 8, wherein the frame information comprises one or more switch network identifiers corresponding to a radar data stream.

12. The computer-implemented method of claim 8, further comprising:
performing a transformation on at least one of the plurality of de-capsulated sensor packets, wherein the transformation comprises one or more of: data compression, or data decompression.

13. The computer-implemented method of claim 8, further comprising:
performing a transformation on at least one of the plurality of de-capsulated sensor packets, wherein the transformation comprises a color space transformation.

14. The computer-implemented method of claim 8, further comprising:
performing a transformation on at least one of the plurality of de-capsulated sensor packets, wherein the transformation comprises a coordinate transform.

15. A non-transitory computer-readable storage medium comprising instructions stored therein, which when executed by one or more processors, cause the processors to perform operations comprising:
receiving, from one or more autonomous vehicle (AV) sensors, a plurality of sensor packets at an accelerated AV network pipeline;
extracting frame information associated with the plurality of sensor packets; and
extracting payload data from the plurality of sensor packets based on the associated frame information to produce a plurality of de-capsulated sensor packets.

16. The non-transitory computer-readable storage medium of claim 15, wherein the frame information comprises one or more switch network identifiers corresponding to a Light Detection and Ranging (LiDAR) data stream.

17. The non-transitory computer-readable storage medium of claim 15, wherein the frame information comprises one or more switch network identifiers corresponding to a camera data stream.

18. The non-transitory computer-readable storage medium of claim 15, wherein the frame information comprises one or more switch network identifiers corresponding to a radar data stream.

19. The non-transitory computer-readable storage medium of claim 15, wherein the processors are further configured to perform operations comprising:
performing a transformation on at least one of the plurality of de-capsulated sensor packets, wherein the transformation comprises one or more of: data compression, or data decompression.

20. The non-transitory computer-readable storage medium of claim 15, wherein the processors are further configured to perform operations comprising:
performing a transformation on at least one of the plurality of de-capsulated sensor packets, wherein the transformation comprises a color space transformation.
